(19) United States
(12) Patent Application Publication
(10) Pub. No.: US 2009/0172920 A1
(43) Pub. Date: Jul. 9, 2009

(54) Apparatus for Connecting Two Sections of At Least One Elongate Object in an Adjustable and Detachable Manner

(75) Inventors: Klaus Hullmann, Lörrach (DE); Helmo Daler, Lörrach (DE); Klaus Blum, Lörrach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: A. RAYMOND & CIE, Grenoble (FR)

(21) Appl. No.: 11/886,988

(22) PCT Filed: Mar. 22, 2006
(86) PCT No.: PCT/EP2006/002614

§ 371 Date: Dec. 8, 2008

(30) Foreign Application Priority Data
Apr. 5, 2005 (DE) 10 2005 015 518.9

(51) Int. Cl. F16G 11/10

(52) U.S. Cl. 24/135 R

(57) ABSTRACT

An apparatus for connecting two sections (8, 9) of at least one elongate object in an adjustable and detachable manner has a receiving housing (1), has two blocking parts (10, 11) which are mounted in the receiving housing (1) so as to be moveable relative to one another and are arranged such that, in an engagement position, they engage so as to clamp in each case one section, and has guide ducts (3, 4) for defined guidance of the sections (8, 9) in the receiving housing (1). The guide ducts (3, 4) are arranged such that they are aligned with one another axially, while the blocking parts (10, 11) are arranged on the same side of the guide ducts (3, 4). This results in a design which, while providing a high degree of locking action, is very simple and is therefore cost-effective to produce.

The invention relates to an apparatus in accordance with the introductory clause of patent claim 1.

Such an apparatus is known from DE 698 21 209 T2. In the case of the previously known apparatus, a receiving housing, two blocking parts and guide ducts are present. The blocking parts are mounted in the receiving housing so as to be movable relative to one another and are arranged such that, in an engagement position, they engage so as to clamp in each case one section. The guide ducts serve for defined guidance of the sections in the receiving housing. In this apparatus, the guide ducts run in the longitudinal direction offset parallel to one another in one plane, while the blocking parts are arranged opposite to each other, in each case on one side of a section with which they come into engagement. This results in a relatively complex design in which, among other things, it is necessary that each blocking part possibly interacts with a separate spring element of a spring arrangement in order to exert a restoring force on the particular section.

The invention is based on the problem of suggesting an apparatus of the type described above that is characterized by a very simple and cost-effective mechanical design which nonetheless results in relatively high retention forces.

According to the invention, this problem is solved with an apparatus of the type mentioned above having the characterizing features of patent claim 1.

Through the fact that in the apparatus according to the invention the guide ducts are arranged such that they are aligned with one another axially and the blocking parts are arranged on the same side of the guide ducts, a design which is relatively simpler but can still be more highly stressed mechanically, and which permits relatively simple manufacture, can be achieved, since now only a single passage formed by the two guide ducts is provided, and mounting of the blocking parts that are aligned with each other can take place on the same side of the guide ducts.

Particularly useful further developments of the invention are the objects of the subclaims.

Additional useful configurations and advantages can be taken from the following description of preferred embodiments of the invention, including references to the figures of the drawing. The following are shown:

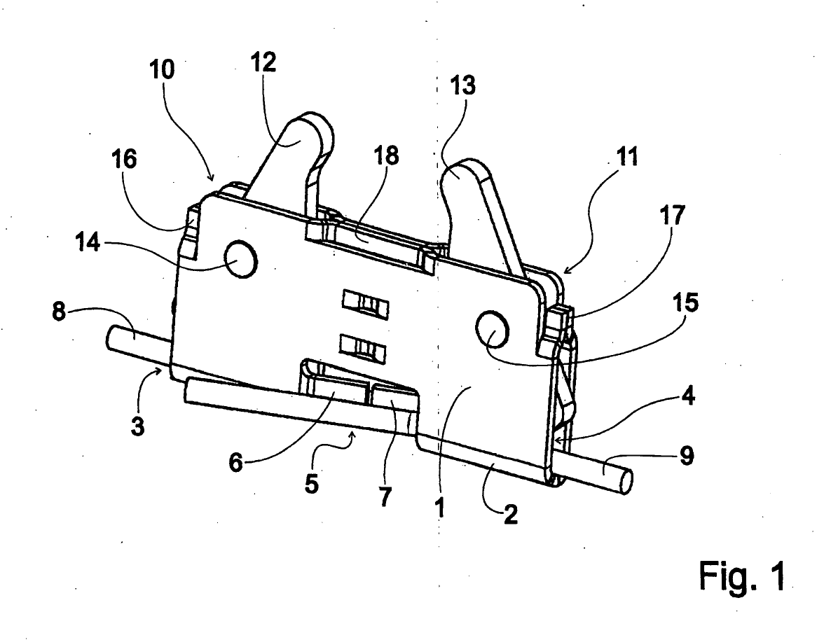

FIG. 1 A perspective view of a first embodiment of an apparatus according to the invention,

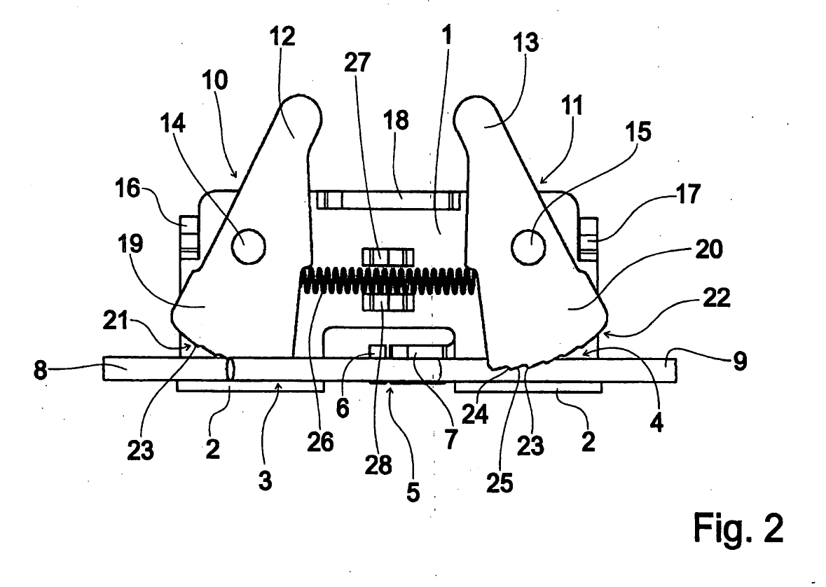

FIG. 2 A partially cutaway side view of the first embodiment according to FIG. 1, having a coil spring as the single spring element of a spring arrangement,

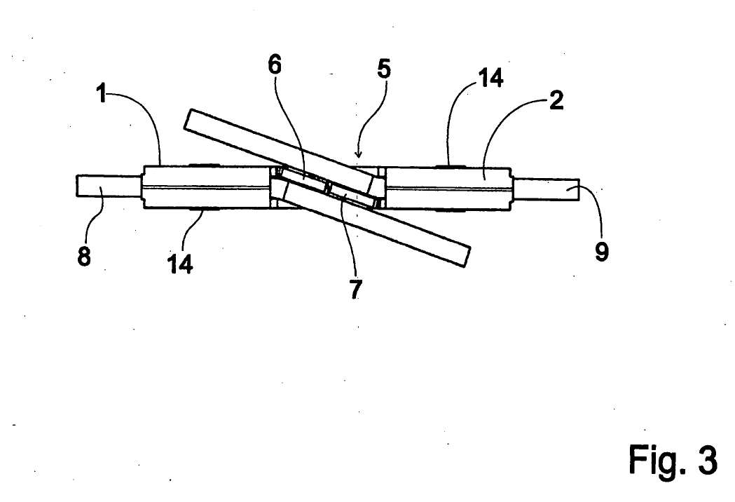

FIG. 3 A view of the first embodiment according to FIG. 1, looking in the direction of the guide ducts,

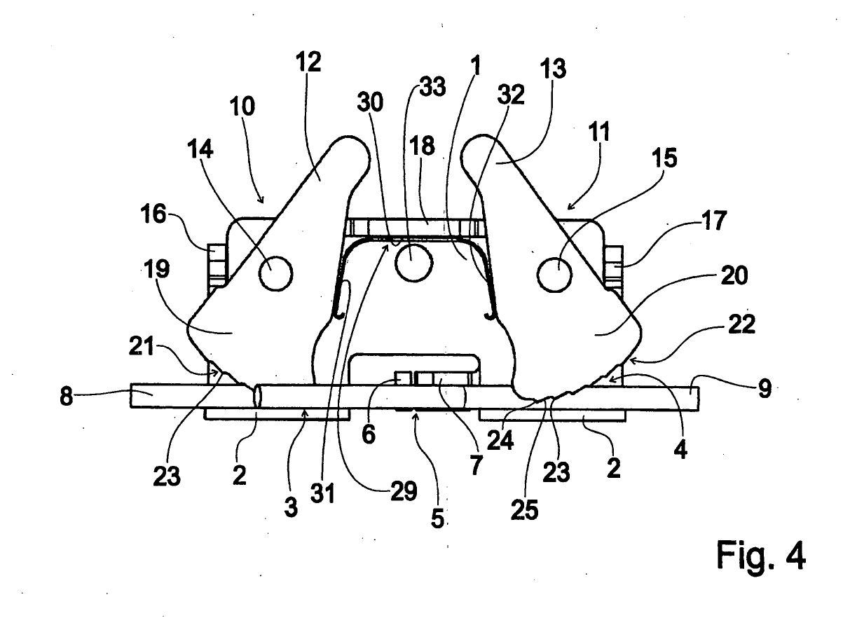

FIG. 4 A partially cutaway side view of a second embodiment, having a leaf spring as the single spring element of a spring arrangement,

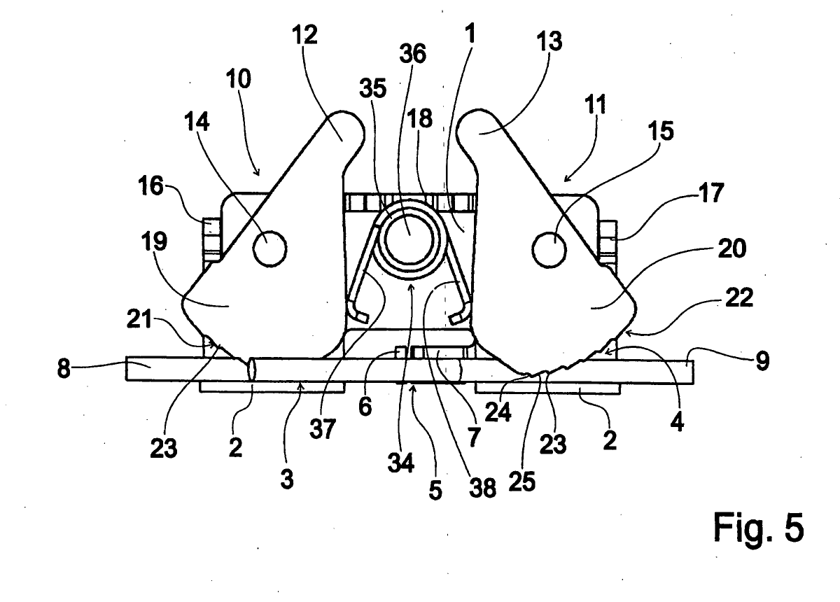

FIG. 5 A partially cutaway side view of a third embodiment, having a wire-wound spring as the single spring element of a spring arrangement, and

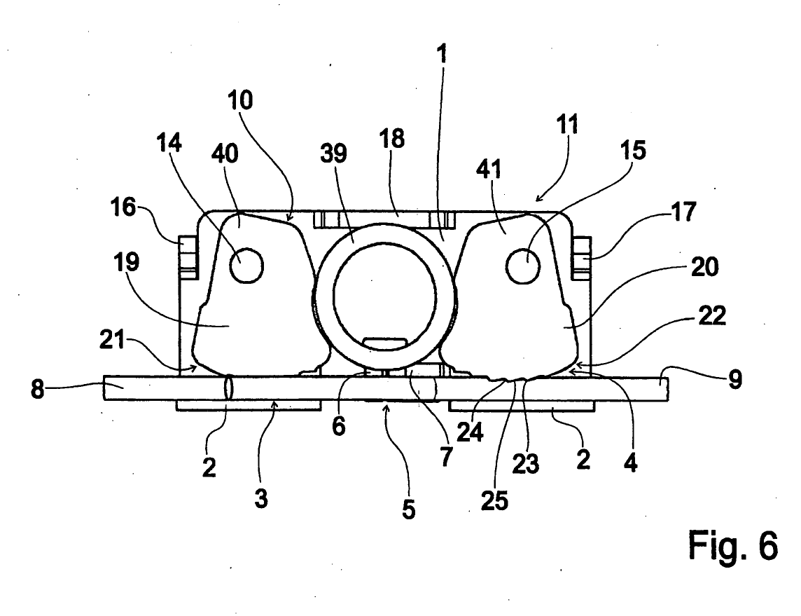

FIG. 6 A partially cutaway side view of a fourth embodiment, having a spring ring as the single spring element of a spring arrangement.

FIG. 1 shows a perspective view of a of a first embodiment of an apparatus according to the invention, which has a receiving housing 1 that is formed from a piece of sheet metal that is bent 180 degrees. Constructed along the bend 2 and delimited in sections by the bend 2 are two guide ducts 3, 4, which extend from the edge sides of the receiving housing 1 in the direction of a free region 5 placed in the middle of the receiving housing 1, and which are aligned with one another axially. In the case of the embodiment according to FIG. 1, present in the free region 5 are two tongues 6, 7, of a deflection arrangement that interrupts the direct connection between the guide ducts 3, 4, which are aligned at an angle to the axial direction of the guide ducts 3, 4 and which at one end are formed on the receiving housing 1, and which are arranged so that their other, free ends point towards one another.

In the illustration according to FIG. 1, inserted into each guide duct 3, 4 is a section 8, 9 of an elongate object, specifically, a steel cable or a wire, whereby as a result of the deflection action of the angled tongues 6, 7, the sections 8, 9 have been directed past each other during insertion into the free region 5 and extend away from the receiving housing 1 at an angle.

It can also be seen from FIG. 1, that the apparatus according to the invention has a first blocking part 10 and a second blocking part 11, which are in each case constructed with a coupling lever 12, 13, which protrudes beyond the open side of the receiving housing 1 that is opposite the guide ducts 3, 4, and which is provided in order to move the blocking parts 10, 11 by means of manual intervention. Each of the blocking parts 10, 11 is connected in rotating fashion with the receiving housing 1 by a pin 14, 15 in both flat sides of the receiving housing 1. In order to limit the freedom of movement of the blocking parts 10, 11 to the required extent, at the edges in the regions of the receiving housing 1 that border the coupling levers 12, 13 there are pinched-in regions 16,17 at the edges plus a central pinched-in region 18 that have been formed by pressing together edge sections of the receiving housing 1 that lie opposite each other.

FIG. 2 shows a partially cutaway side view of the first embodiment according to FIG. 1. It can be seen from FIG. 2, however, that each of the blocking parts 10, 11 is formed with an engagement section 19, 20 that is on the side of the particular pin 14, 15 that is opposite the particular coupling lever 12, 13. Each of the engagement sections 19, 20 exhibits an edge 21, 22, which is acentrically curved and engages with the particular section 8, 9 that is to be fixated, whereby, in order to achieve as good a locking action as possible, the curvature of the bend regions located at the inside is less pronounced than in the regions located at the outside. For good locking action, each edge exhibits ribbing that is formed by a number of teeth 23, whereby each tooth 23 is formed with a steep flank 24 pointing in the direction of the free region 5 and a flat flank 25 pointing in the outside direction.

In the embodiment according to FIG. 2, present as the single spring element of a spring arrangement is a coil spring 26, which works in compression and which is arranged between at least two spring holders 27, 28 that are formed, e.g., by means of stamping, in the receiving housing 1, and is thus secured against movement within the receiving housing 1. Each of the ends of the coil spring 26 lies against an engagement section 19, 20 of a blocking part 10, 11, so that the spring action of the coil spring 26 counteracts the movement of the blocking parts 10, 11 in the direction of the free region 5.

The passing of the sections 8, 9 through the guide ducts 3, 4 proceeds in the manner explained in the following. Following contact of the free ends of the sections 8, 9 with the particular edge 21, 22 of a blocking part 10, 11, by means of a back and forth pivoting of the blocking parts 10, 11, due to the action of the ribbing, each section 8, 9 is conveyed in one insertion direction, from the outside of the receiving housing 1 in the direction of the free region 5. However, by exerting a tensile force that is opposite to the particular insertion direction, the blocking parts 10, 11 block movement of the sections 8, 9 out of the receiving housing 1, unless, as a result of manual operation of the coupling levers 12, 13, the blocking parts 10, 11, as the result of the acentric design of the edges 21, 22 release the sections 8, 9 against the action of the coil spring 26 that acts in compression, and the sections 8, 9 can be withdrawn from the receiving housing 1 in the direction opposite the insertion direction.

FIG. 3 shows a view of the first embodiment according to FIG. 1, looking in the direction of the guide ducts 3, 4 that are partly delimited by the bend 2. It can be seen especially clearly in FIG. 3, that, following insertion into the guide ducts 3, 4 from outside the receiving housing 1, upon entering the free region 5, the sections 8, 9 are deflected outward from their axial alignment with one another in the guide ducts 3, 4 by the tongues 6, 7, which are placed between the ends of the guide ducts 3, 4 that are to point towards each other and, aligned with each other, form essentially continuous deflection surfaces, said sections protruding laterally beyond the receiving housing 1.

FIG. 4 shows a partially cutaway side view of a second embodiment of an apparatus according to the invention, whereby the elements that correspond to those of the first embodiment according to FIGS. 1 through 3 and the second embodiment according to FIG. 4 are given the same reference symbols and thus are not explained further. In the case of the second embodiment according to FIG. 4, the spring arrangement exhibits as the single spring element a leaf spring 29, which exhibits a center section 30 that lies against the side of the center pinched-in region 18 pointing in the direction of the free region 5, and which also has two edge sections 31, 32 which in each case lie against an inward pointing edge side of a blocking part 10, 11 and press the engagement sections 19, 20 outward in the same way as the action of the coil spring 26 in the first embodiment. To secure the leaf spring 29, a fixing arbor 33 that lies on the inside of the receiving housing 1 is formed on the side of the center section 30 that is opposite an edge of the pinched-in section 18.

FIG. 5 shows a partially cutaway side view of a third embodiment of an apparatus according to the invention, whereby the elements that correspond to those of the first embodiment according to FIGS. 1 through 3, the second embodiment according to FIG. 4 and the third embodiment according to FIG. 5 are given the same reference symbols and thus are not explained further. In the case of the third embodiment according to FIG. 5, the spring arrangement exhibits as the single spring element a wire-wound spring 34 that acts in compression, the center section 35 of which is placed with several windings around a winding arbor 36 that is arranged between the central pinched-in region 18 and the free region 5, and the edge sections 37, 38 of which engage at the edges of the engagement sections 19, 20 of the blocking parts 10, 11, said edges to point towards one another.

FIG. 6 shows a partially cutaway side view of a fourth embodiment of an apparatus according to the invention, whereby the elements that correspond to those of the first embodiment according to FIGS. 1 through 3, the second embodiment according to FIG. 4, the third embodiment according to FIG. 5 and the fourth embodiment according to FIG. 6 are given the same reference symbols and thus are not explained further. In the case of the fourth embodiment according to FIG. 6, the spring arrangement exhibits as the single spring element an annular, closed spring ring 39 made from an elastic material such as rubber, for example, which is arranged between the central pinched-in region 18 and the free region 5, whereby the spring ring 39 is secured against falling out of the receiving housing 1 by the tongues 6, 7. The spring ring 39 lies against the, in this embodiment, preferably round-shaped, inward-pointing edges of the engagement sections 19, 20 of the blocking parts 10, 11 and thus exerts a pressing force on them when the blocking parts 10, 11 move inward.

As can be seen from FIG. 6, in the fourth embodiment each of the blocking parts 10, 11 is arranged completely within the receiving housing 1, and, in order to prevent unintentional operation, has in place of the protruding coupling levers 12, 13 in accordance with the previously explained embodiments, operating sections 40, 41, on each of which a tool can be placed in order to deliberately execute a pivoting movement.

1. Apparatus for connecting two sections (8, 9) of at least one elongate object in an adjustable and detachable manner, having a receiving housing (1), having two blocking parts (10, 11) which are mounted in the receiving housing (1) so as to be moveable relative to one another and arranged such that, in an engagement position, they engage so as to clamp in each case one section, and having guide ducts (3, 4) for defined guidance of the sections (8, 9) in the receiving housing (1), whereby the guide ducts (3, 4) extend in the direction of a free region (5) and are aligned with one another axially, while the blocking parts (10, 11) are arranged on the same side of the guide ducts (3, 4), characterized in that in the free region (5), a deflection arrangement (6, 7) is formed, which is arranged between the ends of the guide ducts (3, 4) that are to point towards one another, and which interrupts the direct connection between the guide ducts (3, 4), so that in the free region (5) the sections (8, 9) are guided past each other and extend away from the receiving housing (1) at an angle.

2. Apparatus according to claim 1, characterized in that the deflection arrangement exhibits at least one tongue (6, 7), which is aligned at an angle to the axial direction of the guide ducts (3, 4).

3. Apparatus according to claim 1, characterized in that a spring arrangement (26, 29, 34, 39) that interacts with the blocking parts (10, 11) is present, the spring action of which counteracts the movement of the blocking parts (10, 11) when the sections (8, 9) are inserted into the receiving housing (1).

4. Apparatus according to claim 3, characterized in that a spring arrangement exhibits a single spring element (26, 29, 34, 39) that acts in compression and is arranged between the blocking parts (10, 11).

5. Apparatus according to claim 4, characterized in that the spring element is a coil spring (26), the ends of which are connected with the blocking parts (10, 11).

6. Apparatus according to claim 4, characterized in that the spring element is a leaf spring (29) that is formed with a central section (30) and two edge sections (31, 32), each of which is in engagement with a blocking part (10, 11).

7. Apparatus according to claim 4, characterized in that the spring element is a wire-wound spring (34) that is formed with at least one central part (35) that exhibits a winding, and two edge sections (37, 38), each of which is in engagement with a blocking part (10, 11).

8. Apparatus according to claim 4, characterized in that the spring element is an annular, closed spring ring (39) which is made from an elastic material and which lies in sections against the blocking parts (10, 11).

9. Apparatus according to claim 1, characterized in that at least one blocking part (10, 11) is formed with a coupling lever (12, 13) that protrudes beyond the receiving housing (1).

10. Apparatus according to claim 1, characterized in that the receiving housing (1) that is formed from a piece of sheet metal that is bent 180 degrees, whereby the guide ducts (3, 4) are delimited on the side that points away from the blocking parts (10, 11) by the section of the receiving housing (1) that exhibits the bend (2).

11. Apparatus according to claim 2, characterized in that a spring arrangement (26, 29, 34, 39) that interacts with the blocking parts (10, 11) is present, the spring action of which counteracts the movement of the blocking parts (10, 11) when the sections (8, 9) are inserted into the receiving housing (1).

12. Apparatus according to claim 2, characterized in that at least one blocking part (10, 11) is formed with a coupling lever (12, 13) that protrudes beyond the receiving housing (1).

13. Apparatus according to claim 3, characterized in that at least one blocking part (10, 11) is formed with a coupling lever (12, 13) that protrudes beyond the receiving housing (1).

14. Apparatus according to claim 4, characterized in that at least one blocking part (10, 11) is formed with a coupling lever (12, 13) that protrudes beyond the receiving housing (1).

15. Apparatus according to claim 5, characterized in that at least one blocking part (10, 11) is formed with a coupling lever (12, 13) that protrudes beyond the receiving housing (1).

16. Apparatus according to claim 2, characterized in that the receiving housing (1) that is formed from a piece of sheet metal that is bent 180 degrees, whereby the guide ducts (3, 4) are delimited on the side that points away from the blocking parts (10, 11) by the section of the receiving housing (1) that exhibits the bend (2).

17. Apparatus according to claim 3, characterized in that the receiving housing (1) that is formed from a piece of sheet metal that is bent 180 degrees, whereby the guide ducts (3, 4) are delimited on the side that points away from the blocking parts (10, 11) by the section of the receiving housing (1) that exhibits the bend (2).

18. Apparatus according to claim 4, characterized in that the receiving housing (1) that is formed from a piece of sheet metal that is bent 180 degrees, whereby the guide ducts (3, 4) are delimited on the side that points away from the blocking parts (10, 11) by the section of the receiving housing (1) that exhibits the bend (2).

19. Apparatus according to claim 5, characterized in that the receiving housing (1) that is formed from a piece of sheet metal that is bent 180 degrees, whereby the guide ducts (3, 4) are delimited on the side that points away from the blocking parts (10, 11) by the section of the receiving housing (1) that exhibits the bend (2).

20. Apparatus according to claim 9, characterized in that the receiving housing (1) that is formed from a piece of sheet metal that is bent 180 degrees, whereby the guide ducts (3, 4) are delimited on the side that points away from the blocking parts (10, 11) by the section of the receiving housing (1) that exhibits the bend (2).
